(19) United States
(12) Patent Application Publication
(10) Pub. No.: US 2007/0242228 A1
(43) Pub. Date: Oct. 18, 2007

(54) Compensation schemes for LCoS projection systems using form birefringent polarization beam splitters

(75) Inventors: Jianmin Chen, Superior, CO (US); David A. Coleman, Louisville, CO (US)

Correspondence Address: BAKER & MCKENZIE LLP;PATENT DEPARTMENT, 2001 ROSS AVENUE, SUITE 2300, DALLAS, TX, 75201, US

(73) Assignee: COLORLINK, INC., Boulder, CO (US)

(21) Appl. No.: 11/765,174

(22) Filed: Jun. 19, 2007

Related U.S. Application Data
(60) Provisional application No. 60/821,100, filed on Aug. 1, 2006.

(51) Int. Cl. G03B 21/14

(52) U.S. Cl. 353/20

(57) ABSTRACT

An LCoS projection system provides a form birefringent polarization beam splitter (PBS) having an output modulator port, a light modulating panel, and a biaxial compensation element between the output modulator port and the light modulating panel. In one embodiment, the biaxial compensation element is a biaxial quarter wave plate. In another embodiment, the biaxial compensation element includes a uniaxial quarter wave plate and a biaxial trim retarder. The biaxial compensation element provides improved contrast performance.

### CROSS-REFERENCE TO RELATED APPLICATIONS

This application claims priority to U.S. Provisional Pat. App. No. 60/821,100, entitled “Compensation schemes for LCoS systems using form birefringent polarization beam splitters (PBS),” filed Aug. 1, 2006, which is herein incorporated by reference.

### TECHNICAL FIELD

Disclosed embodiments relate generally to optical devices for use with liquid crystal (LC) display systems, and more in particular to compensation schemes for reflective liquid crystal on silicon (LCoS) projection systems using form birefringent polarization beam splitters (PBS).

### BACKGROUND

Liquid crystal display based front and rear projection systems show great potential for High Definition (HD) and three dimensional video applications due to their superior resolution. Contrast is considered an important performance specification of a projection system, as it ultimately influences the number of true gray levels and the color fidelity. A challenge in such projection systems is to achieve acceptable system contrast despite subtle depolarization effects within the optical modulation system.

Form birefringent PBSs have been used successfully in optical modulation systems as they provide several advantages over alternative PBS technologies. For instance, compared to conventional MacNeille PBSs, form birefringent PBSs offer lower ƒ_{/#} operation with higher transmission and minimal geometrical effects, thus enabling a higher contrast.

A form birefringent PBS typically has a transmitting/reflective interface that transmits a first linear polarization and is reflective to an orthogonal second linear polarization. The transmitting/reflective interface is typically made of multiple polymer quarter wave stacks with alternating high/low refractive index. Such a multilayer structure of anisotropic materials will possess transmitting/reflective spectrum bands centered at different wavelengths for the two orthogonal polarizations. More detail on form birefringent PBSs, which are also known as multilayer birefringent cubes, may be found at M. Robinson, J. Chen and G. Sharp, POLARIZATION ENGINEERING FOR LCD PROJECTION 97-98 (Wiley & Sons 2005) [hereinafter POLARIZATION ENGINEERING], which is hereby incorporated by reference for all purposes. The polymer quarter wave stack is sandwiched by two bulk glass prisms. It acts as a Cartesian polarizer, which does not have the skew ray effect that the MacNeille PBS exhibits. See e.g., POLARIZATION ENGINEERING, p.94-96.

Despite these advantages, there remain performance concerns caused by stress-induced birefringence in both the polymer layers and the surrounding low-index glass. These concerns arise because any intrinsic or induced birefringence alters the polarization state of light, causing non-uniform system performance characteristics, such as poor system contrast, and a non-uniform picture, among others.

Induced birefringence in the PBS can result from several conditions. The first is internal stress due to the forming of glass. Second, bonding and mounting glass components should be done carefully to minimize stress. Third, thermally induced birefringence should be controlled through careful system thermal management. Induced birefringence may also derive from non-uniform expansion of glass by thermal gradients and mismatched material thermal coefficients. The extent to which these thermal effects are seen is related not only to the glass photoelastic constant, but also to absorption, thermal expansion coefficient, and Young's modulus.

Additionally, in projection displays using LCoS or other LC panels, there is a need to compensate residual, OFF-state panel retardance to ensure sufficient contrast performance, because such residual in-plane retardance applied to incident optical rays can cause polarization mixing and lead to OFF-state leakage. This leakage manifests itself as a bright dark-state and one that is often colored. When displaying dark video content, such leakage is very obvious and undesirable. Removing residual OFF-state retardance of the LC panels, or at least its adverse affect, can be achieved by introducing birefringent elements in front of the panel, which was described by U.S. Patent Publication No. US 2003/0128320, to Xiang-Dong Mi, and by M. Robinson in commonly-assigned U.S. patent application Ser. No. 10/908,671, hereby incorporated by reference. Another conventional approach to improving contrast is to use a uniaxial quarter wave plate (QWP).

Given the above problems with system contrast when using form birefringent PBSs, it would be desirable to provide compensation scheme(s) to address these issues.

### SUMMARY

Generally, an LCoS projection system provides at least one light modulating subsystem including a form birefringent polarization beam splitter (PBS) having an output modulator port, a light modulating panel, and a biaxial compensation element between the output modulator port and the light modulating panel. In an embodiment, the biaxial compensation element is a biaxial quarter wave plate. In another embodiment, the biaxial compensation element includes a uniaxial quarter wave plate and a biaxial trim retarder.

According to an aspect, a light modulating subsystem for a projection system includes a beamsplitting and combining element, a light modulating panel, a uniaxial quarter wave plate, and a biaxial trim retarder. The beamsplitting and combining element includes a reflective/transmitting interface and at least one modulator port. The reflective/transmitting interface includes form birefringent material. In accordance with this aspect, the biaxial trim retarder is located between the uniaxial quarter wave plate and the light modulating panel, and the uniaxial quarter wave plate is located between the modulator port and the biaxial trim retarder.

According to another aspect, a light modulating subsystem for a projection system includes a beamsplitting and combining element, a light modulating panel, a biaxial quarter wave plate, and a light modulating panel. The beamsplitting and combining element includes a reflective/transmitting interface and at least one modulator port. The reflective/transmitting interface includes form birefringent material. In accordance with this aspect, the biaxial quarter wave plate is located between the modulator port and the light modulating panel.

In accordance with yet another aspect, a projection system includes a first, second and third light modulating subsystem, and a light collecting element operable to combine modulated light from the first, second and third light modulating subsystems. Each light modulating subsystem includes a form birefringent polarization beam splitter having an output modulator port, a light modulating panel; and a biaxial compensation element. The biaxial compensation element is located between the output modulator port and the light modulating panel. In an embodiment, the biaxial compensation element is a biaxial quarter wave plate. In another embodiment, the biaxial compensation element includes a uniaxial quarter wave plate and a biaxial trim retarder.

Other aspects will be apparent with reference to the detailed description, accompanying figures, and the claims appended hereto.

### BRIEF DESCRIPTION OF THE DRAWINGS

FIG. 1 is a schematic diagram illustrating an exemplary projection system architecture based on a form birefringent PBS optical core in accordance with the present disclosure;

FIG. 2A illustrates a known compensation scheme for a PBS;

FIG. 2B is a schematic diagram illustrating a two-retarder compensation scheme for a form birefringence PBS LCoS projection system in accordance with the present disclosure;

FIG. 2C is a schematic diagram illustrating a single biaxial QWP compensation scheme for a form birefringence PBS LCoS projection system in accordance with the present disclosure;

FIG. 3A is a schematic diagram illustrating an unfolded optical model of an LCoS modulating system in transmissive mode without a QWP in accordance with the present disclosure;

FIG. 3B is a schematic diagram illustrating an unfolded optical model of an LCoS modulating system in transmissive mode with a QWP in accordance with the present disclosure;

FIG. 4 is a graph illustrating the effect of a QWP on suppression of leakage due to birefringence of PBS glass in accordance with the present disclosure;

FIG. 5 is a schematic diagram illustrating a testing apparatus for verifying improvements in contrast for various compensation schemes in accordance with the present disclosure;

FIG. 6(a) is a schematic diagram illustrating an exemplary configuration of a two-retarder compensation scheme for a form birefringence PBS LCoS projection system in accordance with the present disclosure;

FIG. 6(b) is a schematic diagram illustrating an exemplary configuration of a single retarder compensation scheme for a form birefringence PBS LCoS projection system in accordance with the present disclosure; and

FIG. 7 is a three dimensional schematic representation of the birefringence of a retardation film as an index ellipsoid in accordance with the present disclosure.

### DETAILED DESCRIPTION

Disclosed herein are various embodiments of compensators for a projection system utilizing a LCoS/form birefringent PBS modulating system that address the above issues and others. The projected indices of the LC panel and the birefringence of the PBS glass is compensated by the in-plane retardance component (Rₒ) and out-of-plane retardance component (Rₜₕ) of the compensator.

In various embodiments, a compensation scheme for an LCoS/form birefringence projection system uses a biaxial film compensator to compensate for the birefringence. As mentioned above, low index glass used for the prisms in the PBS causes stress and thermally induced birefringence and results in a non-uniform picture on a screen. See, e.g., POLARIZATION ENGINEERING, p. 101-102. Usually, such birefringence is not uniform, so it is desirable to minimize it to achieve a uniform and high quality picture. In order to reduce (if not eliminate) the small birefringence from glass, a quarter wave plate (QWP) may be used in which the optical axis is aligned with the PBS.

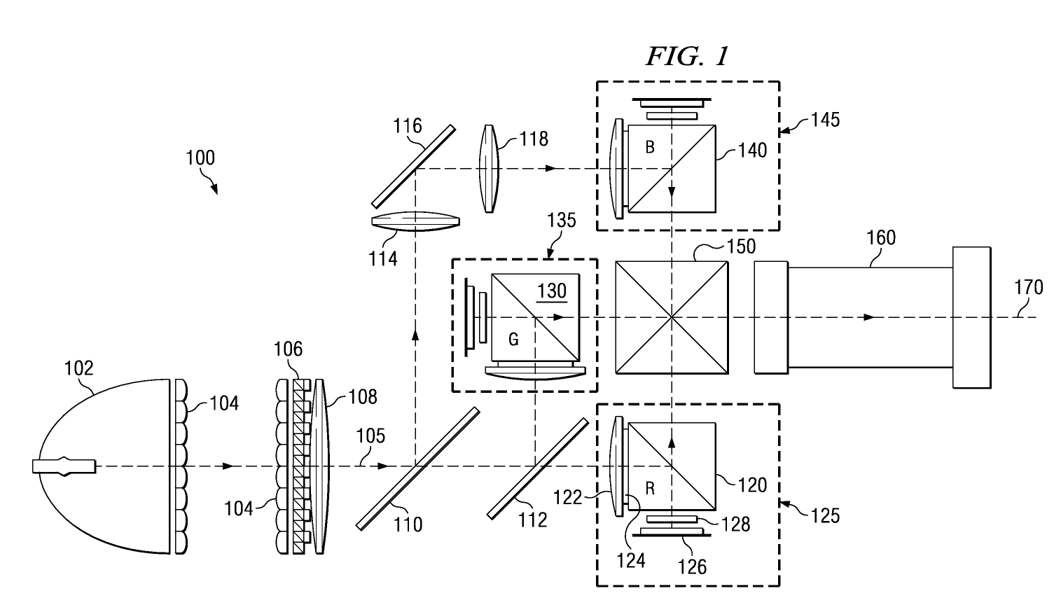

FIG. 1 illustrates an exemplary projection system 100 architecture based on a form birefringent PBS optical core. Generally, projection system 100 includes a first, second, and third light modulating subsystem 125, 135, 145. Each light modulating subsystem 125, 135, 145 generally includes a form birefringent polarization beam splitter (PBS) having an output modulator port, a liquid crystal on silicon (LCoS) modulating panel, and a biaxial compensation element between the output modulator port and the LCoS modulating panel. A dichroic x-cube 150 provides a light collecting element that is operable to combine modulated light from the first, second, and third light modulating subsystems 125, 135, 145, respectively. A projection lens 160 may direct the modulated light 170 toward a projection screen (not shown).

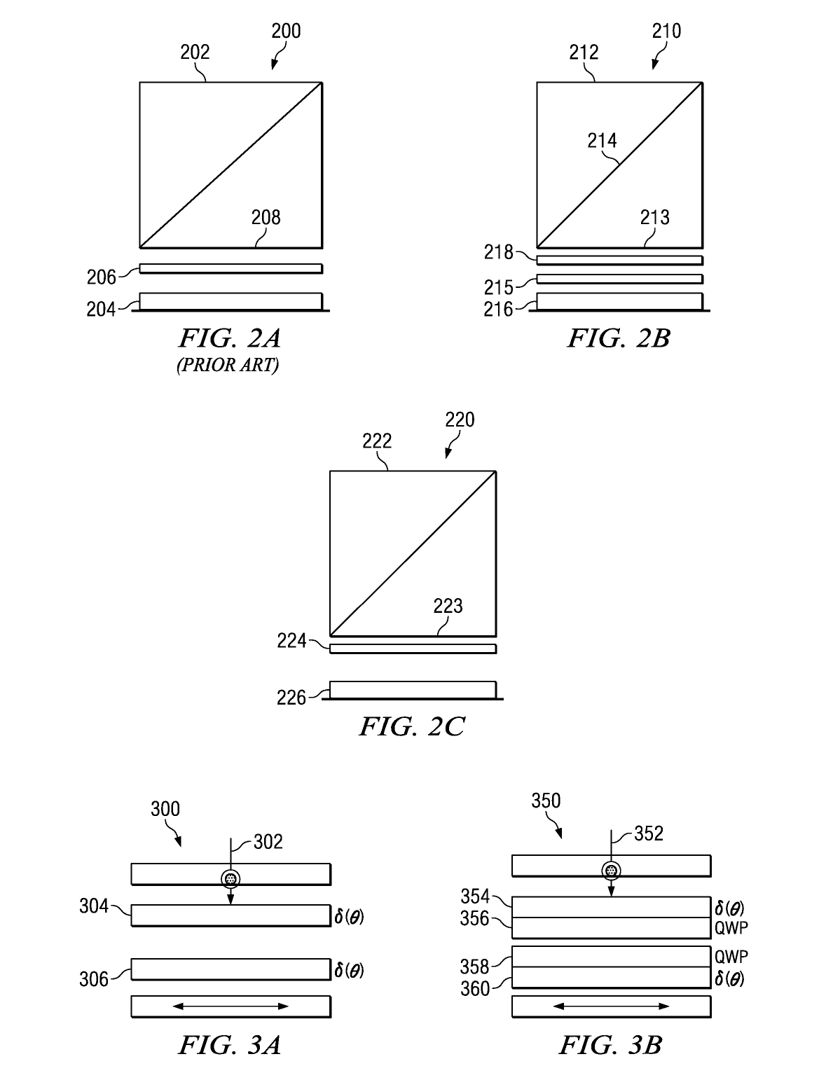

In operation, light is generated by lamp 102 and directed via lens array 104 through PBS array 106 and lens 108, thereby providing collimated light 105. The collimated light 105 is then directed toward dichroic mirror 110, where a red/green light component is transmitted, while a blue light component is reflected. Following the transmitted light path, dichroic mirror 112 then transmits a red light component toward first light modulating subsystem 125, and reflects a green light component toward second light modulating subsystem 135. The blue light component transmitting via lens 114, mirror 116 and lens 118 is directed toward the third light modulating subsystem 145. Generally, for example, light modulating subsystem 125 may include a form birefringent PBS 120, a lens 122 and a clean-up polarizer 124 located at an input port, as well as a compensation element 128 located between an output modulator port of the PBS 120 and a light modulating panel 126 (e.g., an LCoS panel), arranged as shown. Each light modulating subsystem 125, 135, 145 may be of similar design, or may be optimized for the particular color range that it modulates. Further description of light modulating subsystems, and various exemplary embodiments that address the referenced problems are described below with reference to FIGS. 2A and 2B.

Although this exemplary projection system 100 has been provided, it is provided merely as a non-limiting example. It should be apparent to a person of ordinary skill in the art that the teachings of compensator schemes for LCoS projection systems using form birefringent PBSs, as taught herein, may be employed with alternate projection system architectures employing such form birefringent PBSs and LCoS light modulating panels.

FIG. 2A illustrates a known compensation scheme 200 for a PBS 202. This scheme includes a uniaxial QWP 206 disposed between the output port 208 of the PBS 202 and an LCoS panel 204. The uniaxial QWP is used to suppress the leakage due to the birefringence of PBS 202. The optical axis of the uniaxial QWP 206 should be substantially aligned with PBS 202. A deficiency with this known scheme 200 is that the performance of the uniaxial QWP 206 is dependent on the alignment of the QWP 206 with the polarization axis of the PBS 202. If there is misalignment, then performance suffers. A uniaxial QWP 206 alone is very sensitive to its orientation. Further, it provides poor field of view (FoV) compensation effect (if any) on the LCoS panel 204.

A first embodiment of a modulation subsystem 210 that provides more desirable compensation performance is illustrated in FIG. 2B. Modulation subsystem 210 provides a two-retarder compensation scheme for a form birefringence PBS LCoS projection system. The two-retarder compensation scheme of FIG. 2B includes a uniaxial QWP 218 and a biaxial trim retarder 215 interposed between the output port 213 of the form birefringence PBS 212 and LCoS panel 216. The uniaxial QWP 218 provides reduced leakage from the birefringence of the PBS 212, while the biaxial trim retarder 215 provides compensation to enhance the FoV of the LCoS panel 216. The biaxial trim retarder 215 addresses the QWP/PBS angle-sensitivity issue described with reference to FIG. 2A. Accordingly, the trim retarder makes the alignment of optical components 215, 218 less critical and therefore increases manufacturing tolerances, while at the same time contributes to improvements in optical system performance. In order to reduce the cost, the uniaxial QWP 218 and trim retarder 215 may be incorporated into a single component, for example, by laminating two films together.

In a second embodiment of a modulation subsystem 220, providing a compensation scheme for a form birefringence PBS 222, the functions of a uniaxial QWP and trim retarder may be combined into a single biaxial QWP 224 that is located between a modulator port 223 and a light modulating panel 226, arranged as shown in FIG. 2C.

In various embodiments of optical systems relating to FIGS. 2B and 2C, and variations thereof, the trim retarder may be a biaxial retarder, with an in-plane retardance (Rₒ) in the range of 4 nm-30 nm and an out-of plane retardance (Rₜₕ) in the range 150 nm-300 nm. The out-of-plane retardance Rₜₕ compensates for the majority of the LCs OFF-state birefringence. A further discussion with regard to Rₒ and Rₜₕ is provided with reference to FIG. 7.

FIG. 3A illustrates an unfolded optical model 300 of an LCoS modulating system in transmissive mode without a QWP, and FIG. 3B illustrates an unfolded optical model 350 of an LCoS modulating system in transmissive mode with a QWP. Since the head-on ray is being considered here, the LCoS panel can be considered as an ideal mirror when in transmissive mode.

With reference to FIG. 3A, the optical model 300 without a QWP, s-polarized light 302 passes through the prism (shown by block 304), and the leakage induced by the birefringence of the prism is δ(θ). After reflecting from the LCoS panel, the light once again passes through the prism (shown by block 306) and the prism induces leakage of δ(θ) on the return trip, which partially converts the incident state of polarization from s- to p-polarization.

Referring to FIG. 3B, the light (shown by block 352) additionally passes through a quarter wave plate (shown by block 354) on the outbound trip toward the LCoS panel and on the return trip (shown by block 358). As is known from POLARIZATION ENGINEERING, p. 64, light propagating within a birefringent medium can be considered a linear superposition of two normal modes. Accordingly, the leakages induced by the birefringence from prism δ(θ) without and with a QWP can be calculated by Jones' matrix approach. See e.g., POLARIZATION ENGINEERING, p.64-68, hereby incorporated by reference. They are:

$${I}_{leakage ( withoutQWP )} = {sin}^{2} ( 2 θ ) {sin}^{2} ( \frac{πδ ( θ )}{λ} ) \\ {I}_{leakage ( withQWP )} = {sin}^{2} ( 4 θ ) {sin}^{4} ( \frac{πδ ( θ )}{2 λ} ) \qquad ( Equation 1 )$$

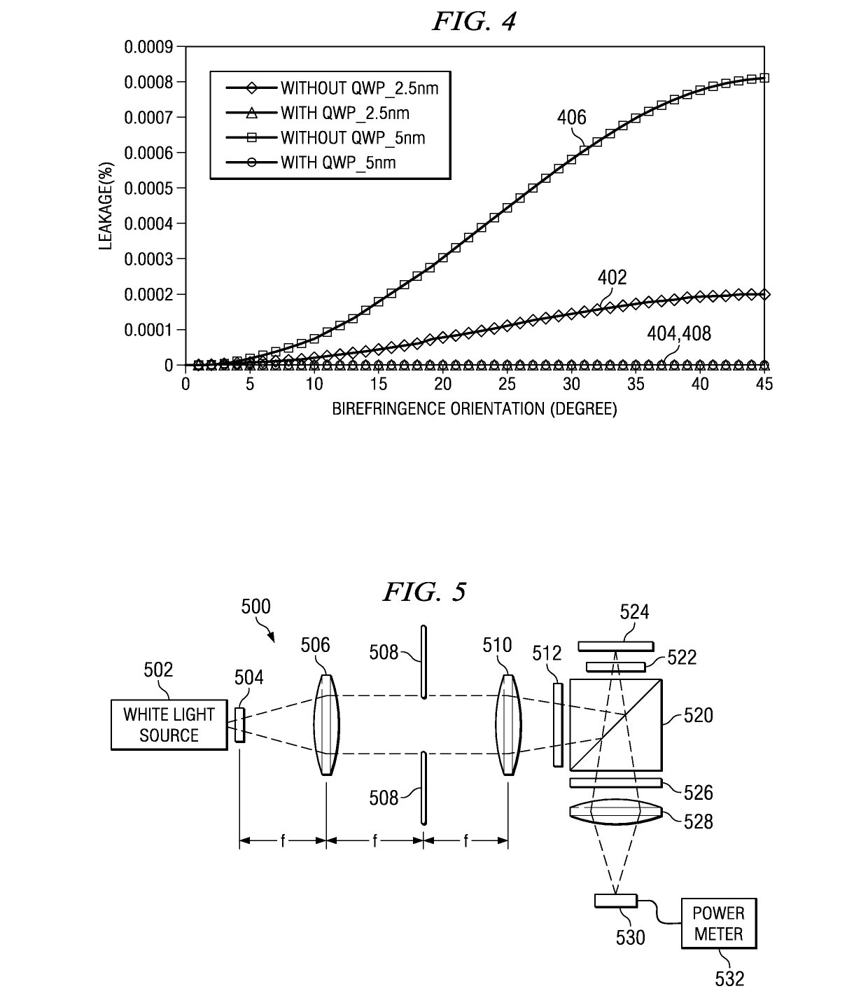

FIG. 4 is a graph 400 illustrating the percentage leakage on the y-axis versus δ(θ) on the x-axis. This graph 400 indicates that a QWP can dramatically suppress the leakage arising from the birefringence characteristics of the glass prism. Lines 402-408 shows that solutions without a QWP (i.e., lines 402, 406) do not suppress leakage due to birefringence from PBS glass as well as solutions with a QWP (i.e., lines 404, 408). Accordingly, a QWP is a beneficial component to enhance system performance and eliminate the picture non-uniformity due to the birefringence of the PBS glass.

FIG. 5 illustrates an exemplary testing apparatus 500 for verifying improvements in contrast for various compensation schemes. Testing apparatus 500 includes a white light source 502, a narrow band filter 504, lenses 506, 510, 528, an illumination attenuator 508, clean-up polarizers 512, 526, a light detector 530, and a power meter 532, arranged as shown. The apparatus under test includes a form birefringent PBS 520, with compensator element(s) 522 between LCoS panel 524.

In operation, light is generated by white light source 502, and passes through narrow band filter 504, which may have a 10 nm full-width half-maximum (FWHW) value at 550 nm. In this exemplary embodiment, the illumination attenuator 508 may provide an aperture with ƒ_{/#}2.5. A pair of lenses 506, 512 direct the filtered light toward clean-up polarizer 512, then through an input port of form birefringent PBS 520. A Vertical Aligned (VA) LCoS panel 524, and a red/green form birefringent PBS 520 may be used, although it should be apparent that other modulating panels may be used, as well as other PBSs. An example form birefringent PBS 520 is the 3M Vikuiti™ PBS. A clean-up polarizer 526 is disposed at the output port of the form birefringent PBS 520. A light detector 530 that receives light directed from the output of the modulation system is coupled to a power meter 532. The power meter 532 provides results that may be used in determining the contrast of the modulation system.

Results from testing exemplary embodiments illustrated in FIGS. 2A, 2B, and 2C are listed in Table 1. Table 1 shows the contrast results from using the test apparatus of FIG. 5, including the known compensation scheme of a single uniaxial QWP [e.g., FIG. 2A], the system contrast with a trim biaxial compensator only [e.g., FIG. 2C], and a two-retarder compensation scheme (QWP/Trim biaxial compensator) [e.g., FIG. 2B]. Clearly, the exemplary embodiment illustrated by FIG. 2B, with a two-retarder compensation scheme provides superior contrast.

TABLE 1
System contrast of LCoS system under
various compensation schemes.

| | | Trim Biaxial | With QWP/trim biaxial |
|---|---|---|---|
| | With QWP only | compensator only | compensator |
| Contrast | 5600:1 | 7000:1 | 8500:1 |

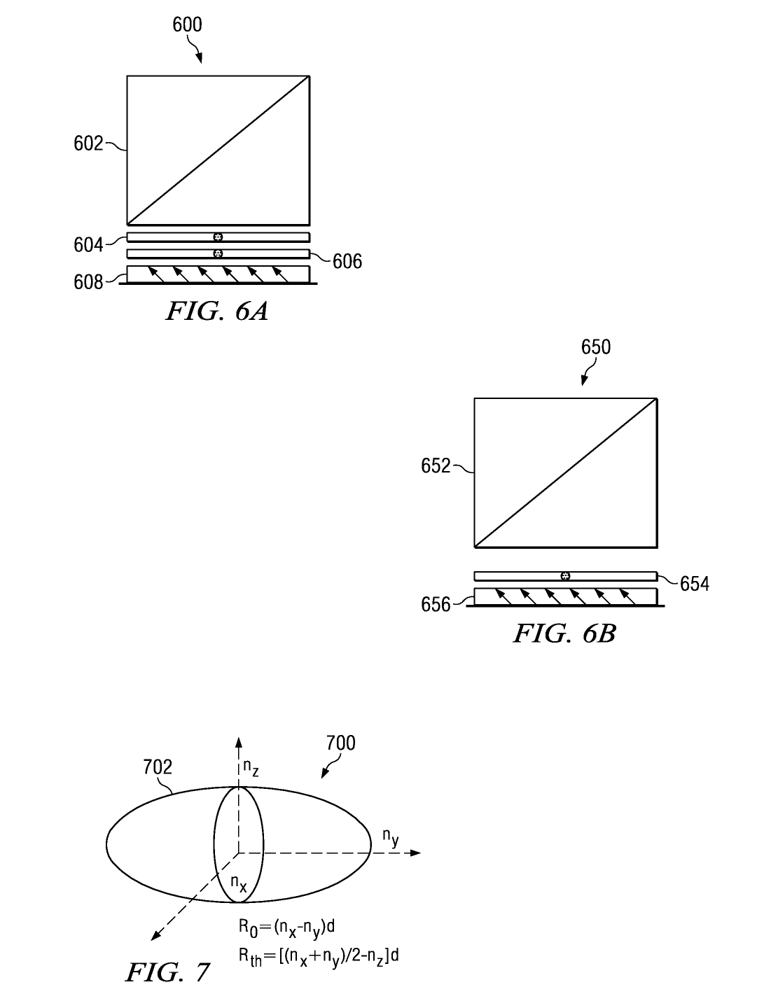

System contrast may also depend on orientation of QWP (s or p), orientation of the trim biaxial compensator (s or p) and the pretilt angle of the liquid crystal panel. An exemplary configuration that is favorable is shown with reference to FIGS. 6(a) and 6(b).

FIG. 6(a) illustrates an embodiment of a modulation subsystem 600 that includes a uniaxial QWP 604 in s orientation (perpendicular to the paper plane), followed by a biaxial trim retarder 606, with the pretilt angle of the LCoS panel 608 generally pointing to the form birefringent PBS 602, arranged as shown in the figure. The impact of variations in orientation of the trim biaxial retarder 606 on contrast is minor. Accordingly, it can be orientated either in s or p, although in this example, it is oriented in the s direction (perpendicular to the paper plane).

FIG. 6(b) illustrates another embodiment of a modulation subsystem 650 that includes a biaxial QWP 654 in s orientation (perpendicular to the paper plane), with the pretilt angle of the LCoS panel 656 generally pointing toward the form birefringent PBS 652, arranged as shown. As should be appreciated, the two-retarder scheme of FIG. 6(a) may be simplified to the single biaxial QWP scheme shown in FIG. 6(b). In various embodiments of the modulation subsystems, the head-on retardation value Rₒ (in plane) may be substantially equal to the wavelength of color band. For instance, in-plane retardance Rₒ may be equal to ˜450 nm, ˜550 nm, and ˜620 nm for the blue, green, and red channel respectively. Out-of-plane retardance Rₜₕ(out of plane) may be in the range from 150 nm to 350 nm.

FIG. 7 is a three dimensional schematic representation 700 of the birefringence of a retardation film as an index ellipsoid 702. Generally, one or more retardation films may be combined to make a compensator. Any retardation film can be characterized uniquely by three refractive indexes nₓ, n_{y} and n_{z}, where nₓ, n_{y} and n_{z} are defined for orthogonal polarization axes. A representation of the three axes is shown by the index ellipsoid 702.

For a single biaxial compensator (retarder), there are two important parameters, Rₒ and Rₜₕ. They are defined as follows:
R₀=(nₓ−n_{y})d
Rₜₕ=((nₓ+n_{y})/2−n_{z})d (Equation 2)
where d is the thickness of retarder. nₓ, n_{y} and n_{z} are the refractive indexes of retardation film in x, y and z direction. The z direction is perpendicular to the film.

It is known that with simple one-dimensional stretching, substantially uniaxial birefringence is formed with associated optical properties. In certain special cases, for instance positive uniaxial stretched films, two of the indexes are substantially equal (e.g., nₓ>n_{y}=n_{z}) and components formed from these materials are termed a-plates if the x-axis is in the plane of the material. Liquid crystal molecules in LCoS panels are typically positive uniaxial with their x-axis (optic axis) parallel to the molecular alignment direction. Negative c-plates are uniaxial with nₓ=n_{y}>n_{z}, where the z-axis is normal to the plane of the component.

More recently, manufacturers have developed two-dimensional (2D) stretching of polycarbonate (PC). Such retarders may be appropriate to address liquid crystal contrast and FOV enhancement requirements. The more complex 2D stretching, which includes shearing, can form layers that exhibit biaxiality. By controlling the extent of biaxiality, improvements in off-axis performance can be achieved. The extent to which off-axis performance is improved can be readily calculated for varying degrees of biaxiality in a viewing plane containing two of the film's three orthogonal optic axes (nₓ, n_{z}). The optical properties of a biaxial film can be characterized by the N_{z} factor, where N_{z}=(nₓ−n_{z})/(nₓ−n_{y}). As described in chapter three of POLARIZATION ENGINEERING, herein incorporated by reference, it can be proven that the retardation in this particular incidence plane is independent to first order in angle when N_{z}=0.5.

It should be appreciated that a single birefringent layer can be approximated by compound structures comprising combinations of retarder films. For example, a combination of an a- and c-plate can, properly designed, yield for certain performance characteristics substantially similar to a single biaxial film. Thus, in this application, the terms “compensator” or “biaxial compensator” includes single or compound retarders performing in this way.

Other embodiments may use crossed nQWP with (n+1)QWP with net head-on birefringence of QWP, where n is an integral number. nQWP may be disposed on either the face of the PBS or the face of the LCoS panel. As used herein, an nQWP has a retardation value of n times of a single QWP. The integer n can be 1,2,3,4 . . . etc. Thus, nQWPs may be made by stacking n QWPs together, or by making a single film with n times of QWP. For instance, a half wave plate is 2QWP, a full wave of 550 nm is 4 QWP at 550 nm, et cetera.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A light modulating subsystem for a projection system, comprising:
a beamsplitting and combining element having a reflective/transmitting interface and at least one modulator port, the reflective/transmitting interface comprising form birefringent material;
a light modulating panel;
a uniaxial quarter wave plate; and
a biaxial trim retarder,
wherein the biaxial trim retarder is located between the uniaxial quarter wave plate and the light modulating panel, wherein the uniaxial quarter wave plate is located between the modulator port and the biaxial trim retarder.

2. The light modulating subsystem according to claim 1, wherein the beamsplitting and combining element is a form birefringent polarization beam splitter.

3. The light modulating subsystem according to claim 1, wherein the light modulating panel comprises a liquid crystal on silicon (LCoS) panel.

4. The light modulating subsystem according to claim 1, wherein the form birefringent material comprises alternating layers of high/low index polymer quarter wave stacks.

5. The light modulating subsystem according to claim 1, wherein the biaxial trim retarder has an in-plane retardance (R₀) in a range between 4 nm and 30 nm.

6. The light modulating subsystem according to claim 1, wherein the biaxial trim retarder has an out-of-plane retardance (Rₜₕ) in a range between 150 nm and 300 nm.

7. The light modulating subsystem according to claim 1, wherein the uniaxial quarter wave plate and the biaxial trim retarder are laminated together.

8. A light modulating subsystem for a projection system, comprising:
a beamsplitting and combining element having a reflective/transmitting interface and at least one modulator port, the reflective/transmitting interface comprising form birefringent material;
a light modulating panel; and
a biaxial quarter wave plate located between the modulator port and the light modulating panel.

9. The light modulating subsystem according to claim 8, wherein the beamsplitting and combining element is a form birefringent polarization beam splitter.

10. The light modulating subsystem according to claim 8, wherein the light modulating panel comprises a liquid crystal on silicon (LCoS) panel.

11. The light modulating subsystem according to claim 8, wherein the form birefringent material comprises alternating layers of high/low index polymer quarter wave stacks.

12. The light modulating subsystem according to claim 8, wherein the biaxial quarter wave plate has an in-plane retardance (R₀) in a range between 4 nm and 30 nm.

13. The light modulating subsystem according to claim 8, wherein the biaxial quarter wave plate has an out-of-plane retardance (Rₜₕ) in a range between 150 nm and 300 nm.

14. The light modulating subsystem according to claim 8, wherein the biaxial quarter wave plate comprises polycarbonate material that has been stretched in two directions.

15. A projection system, comprising:
a first, second, and third light modulating subsystem, each light modulating subsystem comprising:
a form birefringent polarization beam splitter (PBS) having an output modulator port;
a light modulating panel; and
a biaxial compensation element between the output modulator port and the light modulating panel; and
a light collecting element operable to combine modulated light from the first, second, and third light modulating subsystems.

16. The projection system according to claim 15, wherein the biaxial compensation element comprises a uniaxial quarter wave plate and a biaxial trim retarder.

17. The projection system according to claim 16, wherein the biaxial trim retarder is located between the uniaxial quarter wave plate and the light modulating panel, wherein the uniaxial quarter wave plate is located between the modulator port and the biaxial trim retarder.

18. The projection system according to claim 16, wherein the biaxial trim retarder has an in-plane retardance (R₀) in a range between 4 nm and 30 nm, and wherein the biaxial quarter wave plate has an out-of-plane retardance (Rₜₕ) in a range between 150 nm and 300 nm.

19. The projection system according to claim 15, wherein the biaxial compensation element comprises a biaxial quarter wave plate.

20. The projection system according to claim 15, wherein the form birefringent PBS has a reflective/transmitting interface comprising alternating layers of high/low index polymer quarter wave stacks.

21. The projection system according to claim 15, wherein the reflective-type light modulating panel comprises a liquid crystal on silicon (LCoS) panel.
